(19) United States
(12) Patent Application Publication
(10) Pub. No.: US 2003/0130908 A1
(43) Pub. Date: Jul. 10, 2003

(54) Method and system for providing ingredients and recipes for various food items to consumers

(76) Inventor: Eileen Chu Hing, Philadelphia, PA (US)

Correspondence Address: Eric A. Dichter, Wolf, Block, Schorr and Solis-Cohen LLP, 1650 Arch Street, Philadelphia, PA, 19103, US

(21) Appl. No.: 10/337,474

(22) Filed: Jan. 6, 2003

Related U.S. Application Data
(60) Provisional application No. 60/345,036, filed on Jan. 4, 2002.

(51) Int. Cl. G06F 17/60

(52) U.S. Cl. 705/26

(57) ABSTRACT

A method, system, and computer-readable medium for providing consumers (users) with components for meals, including ingredients and recipes, communicates with a user via a computer network, receives an order from the user, allocates the components of the meal to suppliers based on the order and supplier capability, and organizes distribution of the components of the meal to the user by delivering to the users at specified locations or arranging for pick up of the components at various stores or restaurants.

### CROSS-REFERENCE TO RELATED APPLICATION

This application claims the benefit of U.S. Provisional Application No. 60/345,036, filed Jan. 4, 2002, the entire disclosure of which is incorporated herein by reference.

### FIELD OF THE INVENTION

The present invention relates to a method and system for providing ingredients and recipes for various food items to consumers. More particularly, the present invention is directed to a method, system, and computer-readable medium to receive orders for meals, process the orders, gather ingredients and recipes, and distribute the ingredients and recipes, while providing advertising to suppliers of ingredients and recipes.

### BACKGROUND OF THE INVENTION

Preparation of meals for individuals and families is often labor intensive and time consuming. Providing an easier, cost-efficient, satisfying system in which meals can be prepared and/or distributed to consumers is desirable and has been attempted with varying levels of success. Essentially, working people often do not have the time to cook meals from scratch; thus, they resort to delivery or take-out from fast food establishments, restaurants, and establishments specializing in take-out and delivery. Often, the expense is high and the nutritional value of meals received from such establishments is less than desirable.

Various companies sell frozen foods that can be reheated and served, or require more preparation. Nevertheless, these frozen products still may require preparation, the use of recipes, and may provide only limited ingredients for a meal. In addition, freezer storage space may be limited, precluding the storage of a large amount of frozen items.

There have been several attempts to solve this problem by use of Internet programs and devices. For example, one web site has offered restaurant take-out and delivery service; however, the prices for those food items and delivery make them prohibitive for some people. Another web site has offered kits for preparation of meals, but also at a high price. Additional web sites offer grocery delivery service, some of which use the operating system of a handheld personal digital assistant (PDA), such as the Palm operating system; however, recipes for meals are generally not provided and the food ingredients still need preparation (e.g., washing, cutting, mixing, etc.). Other Internet methods of take-out and delivery have been focused on a particular geographical area with no service in many areas.

Many people dine at restaurants to avoid having to prepare meals; however, restaurant dining is not a practical alternative to many people based on price, location of restaurants, and the practicality of bringing an entire family to a restaurant. Particularly, the time it takes to travel to and from a restaurant and eat the meal can be prohibitive.

Thus, there is a need for a method and system of processing and distributing ingredients and recipes for meals which allow for convenient, reasonably priced, nutritious, home cooked meals with an interesting array of choices.

### SUMMARY OF THE INVENTION

The present invention comprises a synergistic method, system, and computer-readable medium for providing consumers with components for meals, including ingredients and recipes, which facilitate easy and efficient cooking of meals at home. In addition, the present invention provides advertising to the participant restaurants and stores. The user (customer) may be able to access software on a computer network, such as an Internet web site, through a computer, a cellular telephone, a PDA, or telephone connection, to view a menu of meals for delivery or pick up. In one embodiment of the method, a user orders using the network, the order is processed such that restaurants, farmers markets, and supermarkets produce non-fish/non-poultry/non-meat components; butchers, fishmongers, and/or poultry vendors supply meat, fish, and/or poultry; in some cases, one of the above entities may supply all of the components. The components are delivered to the users at specified locations or, alternatively, the user picks up the components at various stores or restaurants.

The present invention can be implemented such that the components to be provided to users are processed during a downtime in the restaurant or store. This will allow utilization of existing employees and infrastructure to provide the services of the method and system of the present invention. In addition, the web site or other vehicle for ordering can provide advertising for the restaurants or stores providing components. Further, users' physical access to restaurants and stores for picking up components can provide walk-through business and exposure to the restaurant and/or store.

It is to be understood that the foregoing general description and the following detailed description are exemplary, but not restrictive of the invention.

### BRIEF DESCRIPTION OF THE DRAWINGS

The present invention is best understood from the following detailed description when read in connection with the accompanying drawings. It is emphasized that, according to common practice, the various features of the drawings are not to scale; rather, the dimensions of the various features are arbitrarily expanded or reduced for clarity. Included in the drawings are the following figures:

FIG. 1 is a schematic showing the steps of the method and system of the present invention.

FIG. 2 is a schematic showing the steps of receiving, processing, and assigning suppliers for orders according to the present invention.

FIG. 3 is a schematic showing the step of assigning restaurants for orders according to the present invention.

FIG. 4 is a schematic showing the step of assigning protein purveyors for orders according to the present invention.

FIG. 5 is a schematic showing the step of assigning suppliers for orders based on availability according to the present invention.

FIG. 6 is a schematic showing order information according to the present invention.

FIG. 7 is a schematic showing the records from the system, a restaurant, and a protein purveyor according to the present invention.

FIG. 8 is an example of an order record according to the present invention.

FIG. 9 is an example of a protein purveyor supplier record according to the present invention.

FIG. 10 is an example of a restaurant supplier record according to the present invention.

### DETAILED DESCRIPTION OF THE INVENTION

The present invention comprises a method, system, and computer-readable medium for providing consumers with pre-prepared ingredients and recipes for meals. The present invention comprises a high concept, high tech, and cost efficient model for conducting a business via a computer network, such as through the Internet. It consistently utilizes the excess capacities of existing infrastructures, e.g., ingredients and recipes can be prepared and distributed during downtime of an existing restaurant/store, such that the existing infrastructures are formed into vast networked entities and incorporated into the framework of the business model. Each networked entity is an outsourced process module of the business model framework. Accordingly, the method and system do not need to be limited geographically in their reach; suppliers and users can be geographically spread out and be linked up by the system.

The present invention continually builds on the synergies of the networked infrastructures, i.e., different suppliers, and expands and contracts as needed. The present invention can stimulate the economy by increasing output of various members of the food industry and information technology companies, such as telecommunications, hardware manufacturers (makers of PDAs, personal computers, cellular phones, storage devices, etc.), software companies, and Internet and cable providers. Also, the present invention can improve the nutrition of individuals using the method and system, e.g., Americans. In one embodiment, the present invention comprises a wireless mobile e-commerce solution involving ordering and distribution of pre-prepared food.

The present invention solves the management problems of excess inventories and capacities of existing brick and mortar infrastructures, e.g., restaurants and stores. It transfers their downtime into uptime, in an economically productive sense. The improved e-business model uses a low cost, low inventory, and direct sales approach. It allows the experts in the field, e.g., chefs, butchers, etc., to contribute their expertise to the system automatically and facilitates innovation.

The method and system can be set up quickly and cost efficiently by outsourcing their processes to a vast network of suppliers and distributors. It is a system set up to stimulate or generate innovation and synergy and falls within the momentum of the 24/7 realm.

Essentially, the invention provides a time saving food preparation service for the consumer. It allows a consumer to prepare a well thought out meal in a short span of time at a competitive price. It brings the expertise of the chefs to consumer's fingertips.

The invention is cost efficient and does not require massive inventory or real estate. In addition, it has an efficient method of distribution and does not rely heavily on mail carriers, i.e., UPS, Federal Express, Airborne Express, U.S. Postal Service, etc. The invention operates in a virtually virtual space, approaching virtuality.

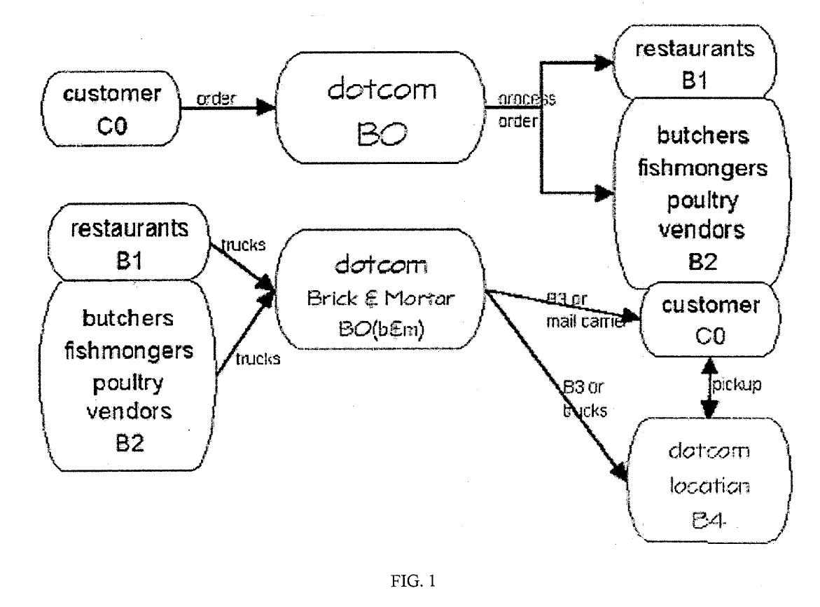

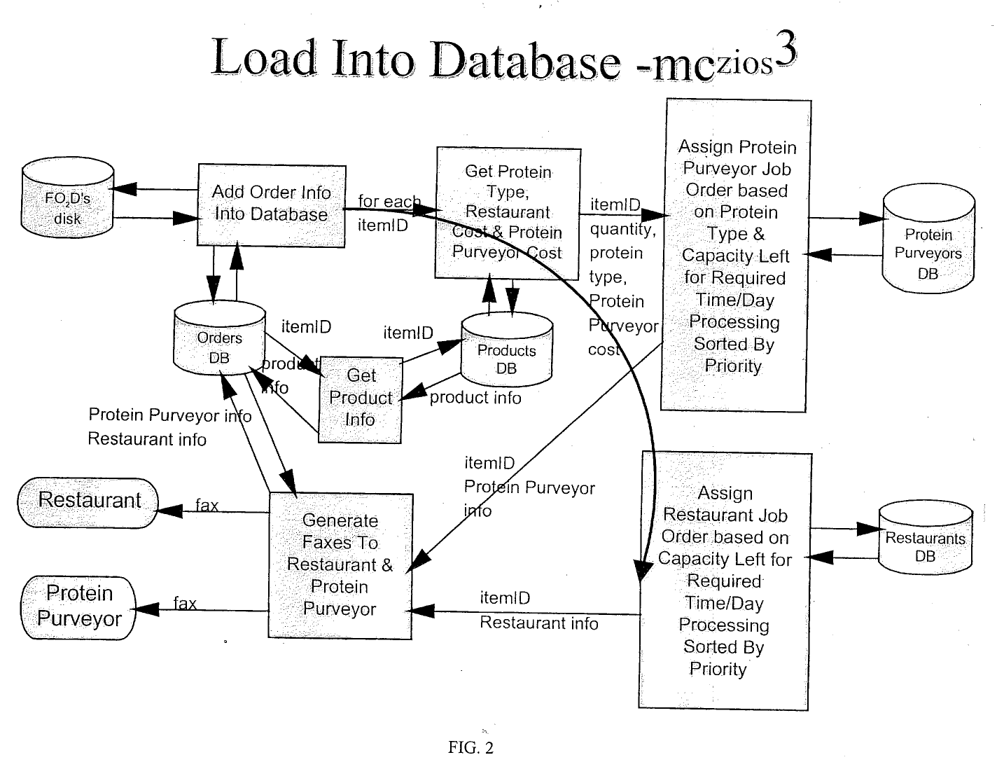

In the method and system (as carried out by the computer-readable medium having executable instructions) for providing components of a meal to a user, as shown in FIGS. 1 and 2, the system receives a meal order from a user of the system and adds it into the system database. In a preferred embodiment, the system utilizes a computer for processing. The order may be in a customized form for transmission through a computer network, such as the Internet; the form is capable of being encrypted. The computer network may be accessed through a landbased line, through a traditional PC, or a wireless connection, such as through a PDA or cellular telephone.

The order may be received from an existing user or a new user, possibly in response to a communication generated by the system, such as an advertisement sent via e-mail. The communication may contain a recipe, a special meal, or a special component of a meal, e.g., fresh ingredient(s) or recipe(s) for the day. Portions of the communication may be identical for all users of the system or customized based on a return user's preferences. Each user's preferences are maintained in a historical database containing a record for each user.

Each user order contains components of a meal, e.g., protein component (e.g., meat), vegetables, fruits, sauces, spices, etc., which are pre-prepared by suppliers of the components. The protein component comprises meat, including, but not limited to, beef, pork, and venison; poultry, including, but not limited to, chicken, cornish hen, duck, ostrich, and turkey; and seafood. The supplier of the protein components is a protein purveyor, which may be a butcher, fishmonger, restaurant, market (farmers market or supermarket), or any other entity which can supply the desired components. The non-protein components, the “vegetable and spice components,” comprise vegetables, spices, fruits, sauces, recipes, and any other non-protein components. Generally, the supplier of the vegetable and spice components is a restaurant or market (farmers market or supermarket). For example, the vegetable and spice components may be supplied by vegetable vendors and spice vendors in a farmers market; salads can be prepared by the produce vendors and spice packets can be assembled in a spice shop. In certain instances, the protein purveyor (supplier of the protein component), market (farmers market or supermarket), or any other entity which can supply the protein components also supplies vegetable and spice components.

In addition to the components, the order further comprises criteria related to the order and corresponding transaction. These criteria are the quantity of components, whether the order proceeds via delivery or pickup, delivery site, user address, pickup site, payment type, delivery time, pickup time, and price. The criteria are also placed in fields of the order database.

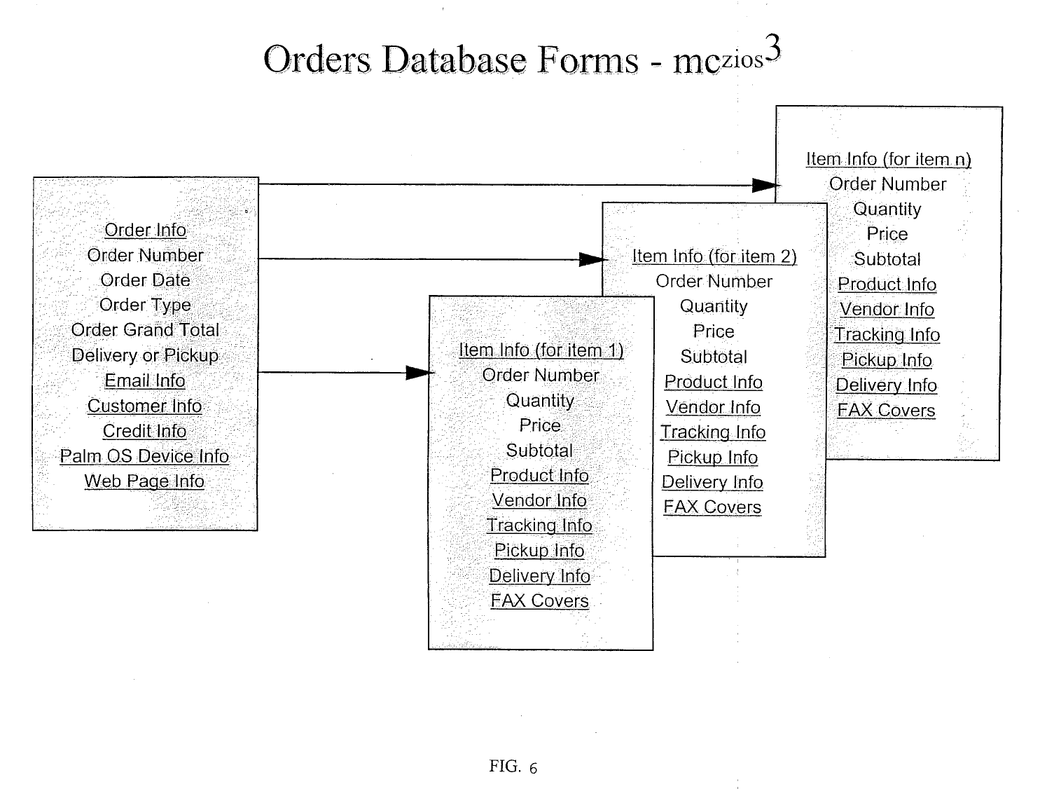

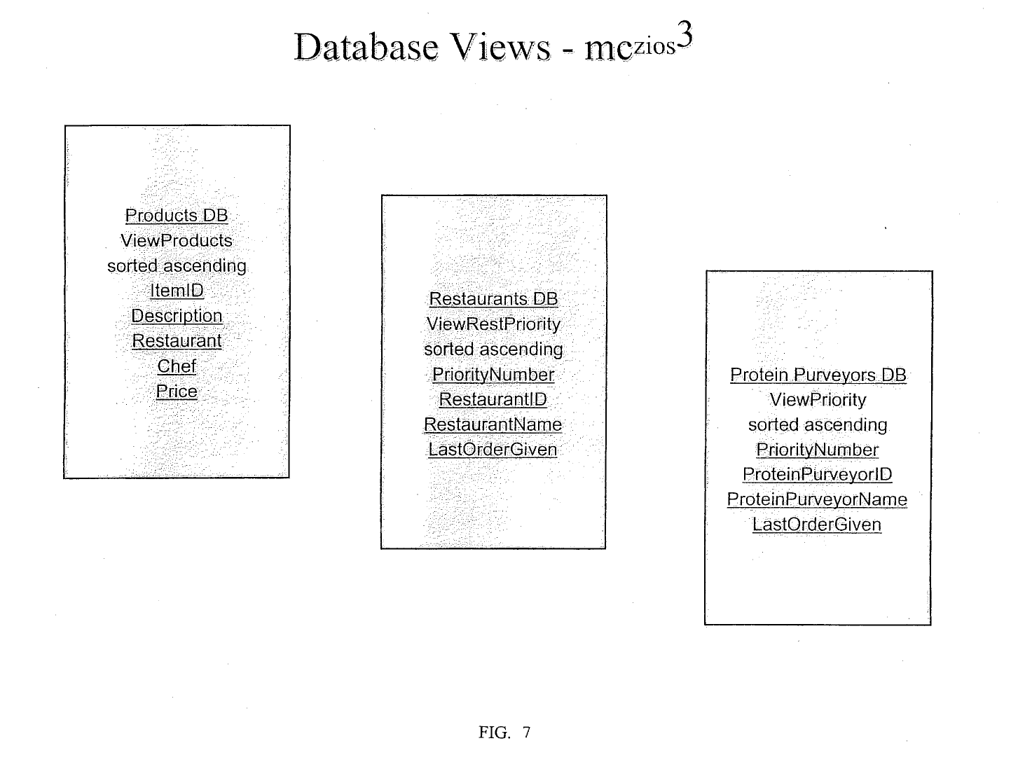

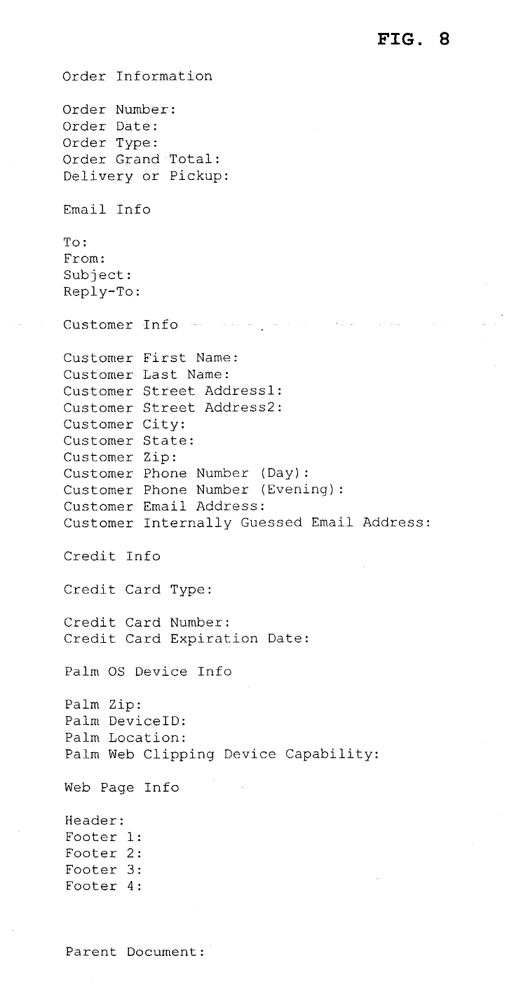

FIG. 6 shows the order record in the database containing the criteria described above and system items (added by the system) for processing, such as order number, order date, order type, user contact information (including, but not limited to, e-mail address), user information, and computer operating system. FIG. 7 shows the various database entries for the system (labeled “Products DB”), restaurant, and protein purveyor. In addition, FIG. 8 shows an order form with components, criteria, and other information. Each order can have one or more items (meals); each item (meal) can have different components and criteria, such as supplier(s), price, recipe, tracking identification, etc.

As an example of the data contained in an order, the order may also contain the following fields: quantity, price, subtotal, item ID, description, showcased restaurant, showcased restaurant ID, showcase chef, recipe, restaurant ingredient ID, restaurant ingredient description, restaurant ingredient cost, protein ID, protein description, protein type, protein cost, vendor information (not assigned, restaurant purveyor, restaurant purveyor ID, restaurant processing day, restaurant processing time, protein purveyor, protein purveyor ID, protein purveyor processing day, protein purveyor processing time), tracking information (barcode number, status, comments), pickup information (location, date, and time), and delivery information (street address(es), city, state, zip, phone number, comments).

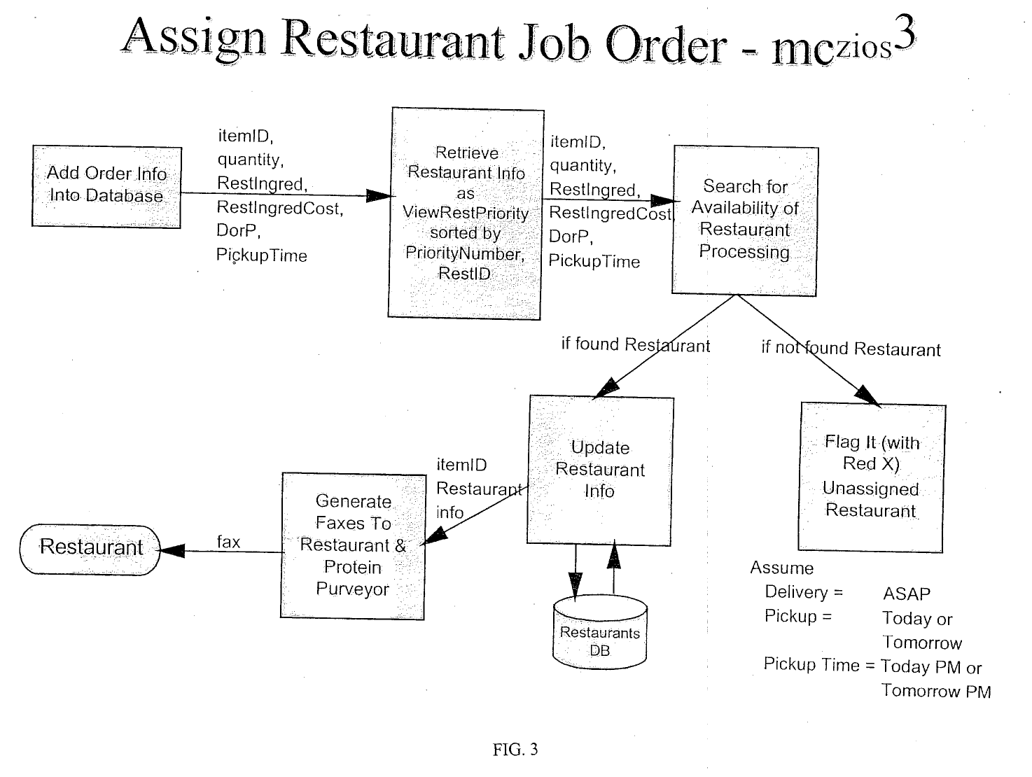

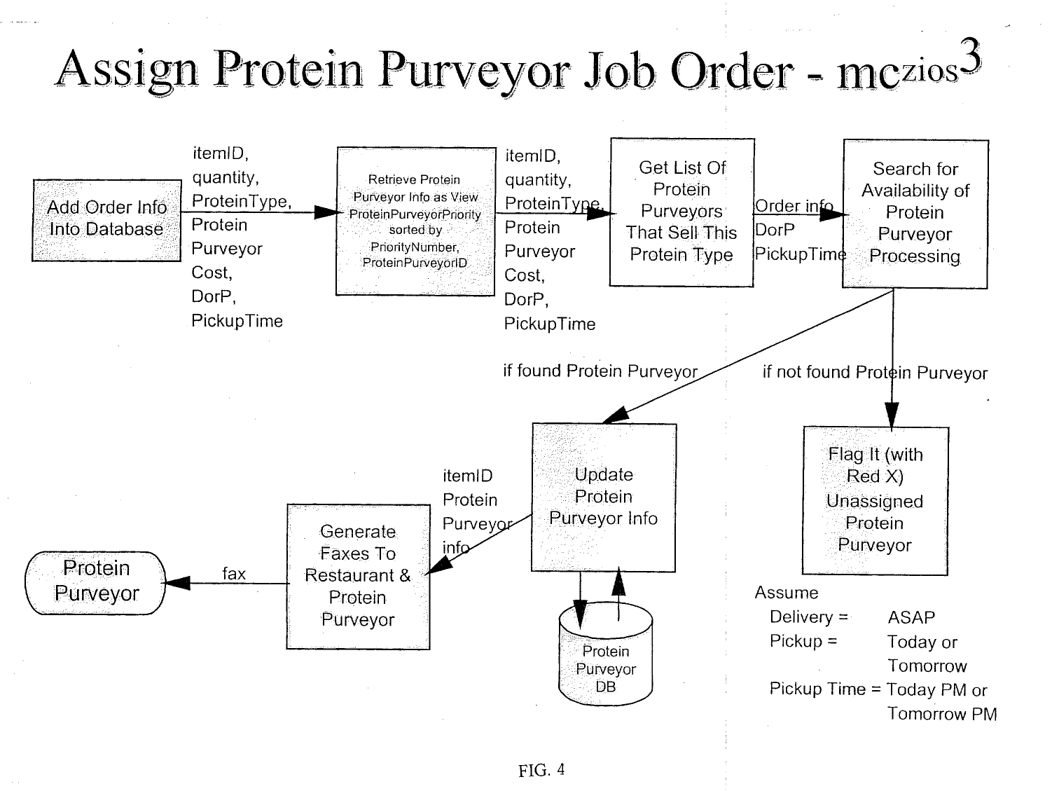

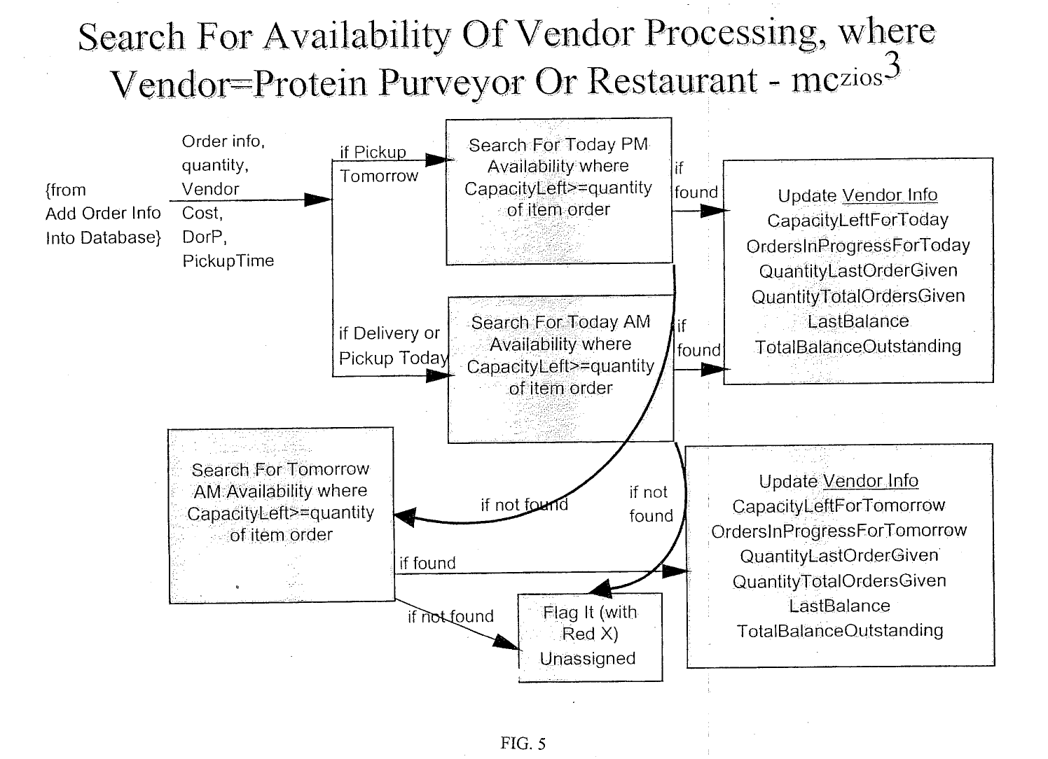

Once the order is received and added to the database, as shown in FIGS. 3-5, the order is confirmed with the user, such as by an e-mail message; the user is also given a reference to track the order, such as a page of a web site or URL. In addition, as shown in FIG. 2, the components of the order are assigned to suppliers and the assigned suppliers are notified of the assignment and the timetable for supplying the components.

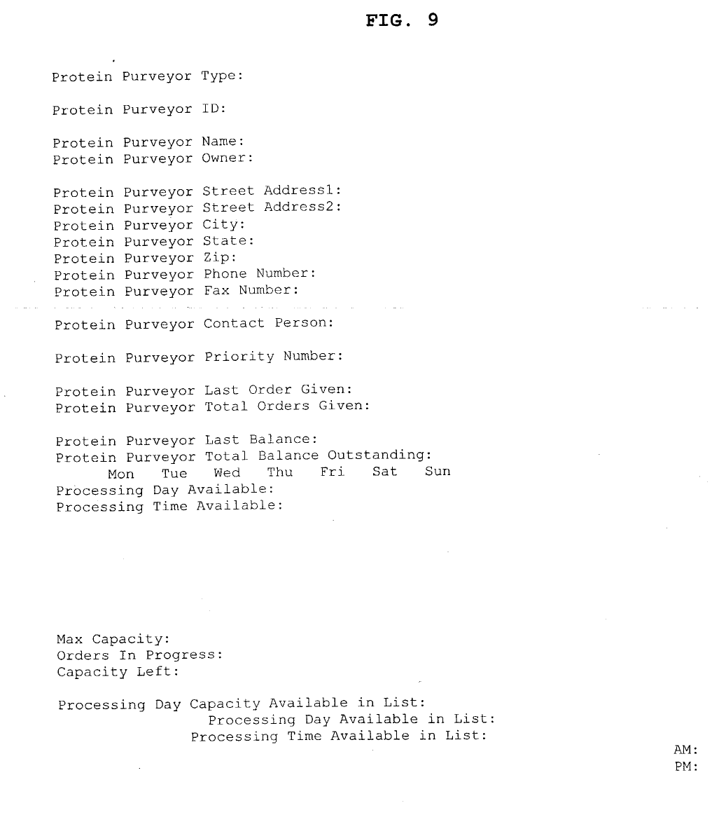

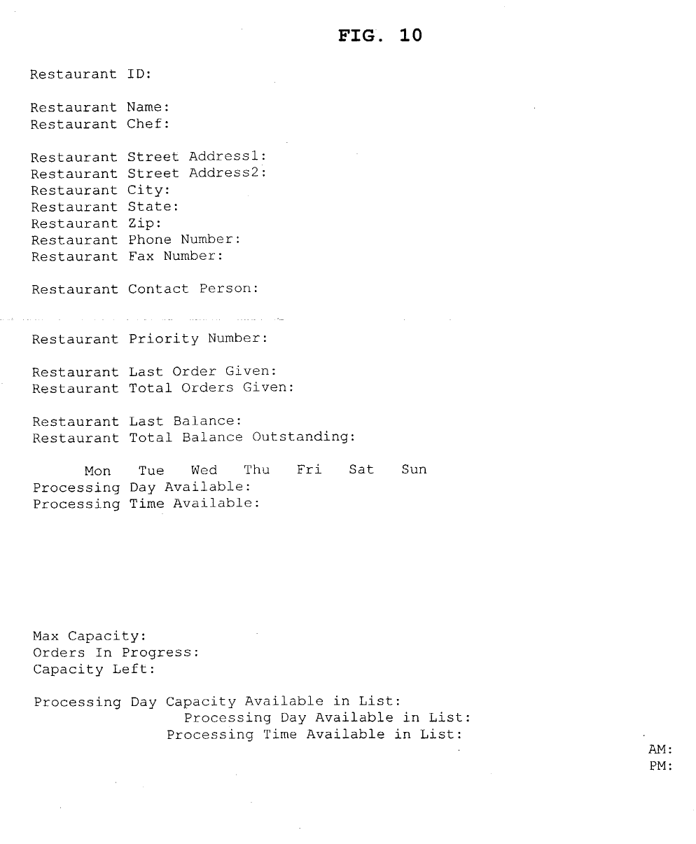

The suppliers for the system are contained in a database of suppliers. FIGS. 9 and 10 are examples of the fields of information contained in the database. The supplier database includes the each supplier's availability of components (i.e., available time to prepare components of an order), the supplier capacity for components, including, the timetable for supplying quantities of components, component pricing, and historical performance data on that supplier. The supplier database is updated periodically based on information transmitted by the supplier to the central system of the present invention. The supplier database may be updated in real time or at a specific time interval, such as half-hourly, hourly, daily, weekly, monthly, quarterly, yearly, etc. The historical performance information recounts past dealing such as, always delivers on time, usually does not meet capacity committed, does not have fresh produce, etc.

Once the components needed for an order are determined, the suppliers of the components of the order are ranked within the supplier database based on the availability of components, the supplier capacity for components, including, the timetable for supplying quantities of components, component pricing, historical performance data, or any other variable set by the system. The ranking is based on the aggregate of individual scores for each supply criteria. For example, if Restaurant A scores 3 on a scale of 1 to 5 for availability of a component (with the lower number indicating the highest availability) and 2 for historical performance, its aggregate score is 5, and if Restaurant B scores 1 for availability and 5 for historical performance, its aggregate score is 6; Restaurant A will rank higher than Restaurant B. Suppliers can then be assigned components of orders based on the supplier rankings. When there are multiple orders, optionally for the same meal and/or components, the system can rank the priority of the orders based on the delivery time or pickup time and availability of suppliers and assigns suppliers based on the priority of the orders and the supplier rankings. Alternatively, the suppliers can be selected based on arbitrary criteria, a rotation system, or user preference.

In one embodiment of the invention, once the supplier is notified, the supplier can respond negatively to the request for a component and send that negative response to the system. Once a negative response is received, the component is reassigned to an additional (second) supplier based on the supplier database ranking for the order or any other criterion set by the system. This process is repeated until the supplier accepts the assignment and/or no negative response is received from the supplier.

Once the components are assigned to suppliers, distribution of the components is organized. All or a portion of the components may be delivered to the user and the user may pick up all or a portion of the components. The pickup location can be the supplier location, a central site, or any other place where the user can pick up components.

The system assigns each component and the order as a whole, when appropriate, a tracking identification which may be a scannable bar code, card (such as an SD card), tag, chip, or any suitable device that can emit a signal which can monitor its location. Technology used with the tracking identification can include Bluetooth, WiFi technology (802.11), radio-frequency technology, or any other preferably wireless tracking technology. This enables each supplier, pickup site, or delivery site to scan the component, in some cases automatically by the tracking identification being in proximity to a reader; the system and/or user can identify the status (i.e., location) of the component.

In one embodiment of the invention, once the timetable for delivery or pickup are established, the system notifies the user of the delivery site, pickup site, delivery time, pickup time, and cost. The system allows the user to change any of these items by sending notification to the system. If any aspect of the order is changed, the system checks the assigned suppliers and alters the assignments, as necessary according to the steps described above, to satisfy the order. The criteria of the order, e.g., price, may also be changed by the system.

After the order is processed, the components and criteria for each user order are stored as a user record in a user preference database. This user preference database is used to process future orders of a return user, and send and/or customize communications to users based on their user records. In this database, sensitive data can be stored in an encrypted format.

After the components are supplied, the system approves and/or transmits payment to the suppliers. In addition, after the components are picked up by and/or delivered to the user, the system collects payment from the user. The timetables for payment and collection may be varied depending on user, supplier, and system preferences and requirements. For example, payment may be made in real time upon completion of the transaction, within a certain amount of time from completion, or periodically, such as monthly. Payment may be made by conventional means, such as, cash, check, credit card, etc., or transmitted electronically.

As shown specifically in FIG. 1, Module C0 is the user who is any food consumer/customer. Module B0 is the dotcom of the system, i.e., web site, in the virtual realm. Orders are processed through the system web site 24 hours a day, 7 days a week (24/7). Sales personnel can be available to address any questions and take orders by phone.

Module B1 is the network of restaurants. They are responsible for providing the dotcom with recipes and for pre-preparing all of the ingredients, except, in most cases, the protein component (as defined above). As specified above, generally, the protein component is supplied by specialty stores, such as butchers, fishmongers, etc.; however, restaurants may provide those components, if necessary.

Pre-preparation, includes, but is not limited to, washing, chopping, measuring, preparing some sauces, and packing the components. The vast network of restaurants can execute all the necessary preparatory work for the components, except in some cases the protein component, and package them. The network of restaurants provide a broad capability, i.e., power. The restaurants process these orders during their downtimes. All restaurants must meet health and safety codes to participate with the dotcom. The restaurant network benefits by receiving free advertising from the dotcom; the dotcom showcases the restaurant and chef on the web site.

Module B2 is the network of protein purveyors. They are responsible for that component of the recipe. Buying in large volume provides the network with the best cuts at competitive prices. These purveyors pre-prepare and pack the protein component. These portions are cut, packed, and ready to cook according to the specifications of the recipe. Optionally, the protein purveyors may prepare the protein component, e.g., marinate the meat. The protein purveyors can process these orders during their downtimes. Like with the participating restaurants, the dotcom can require that they must all meet health and safety codes in order to participate in the system.

Module B0 (b&m) is the brick and mortar part of the dotcom. It is the quality control, packaging, and distribution center. This may be a separate central location, or an existing farmers market or supermarket.

Module B3 is the network of third party delivery services. This includes, but is not limited to, taxi cab services, limousine services, trucking services, and courier services. The taxi cab and limousine services would increase their business and gain name recognition. The taxi/limousine network would be placed in a queue for on call delivery service during their slow times. The trucking and courier services would be utilized during their downtimes.

Module B4 is the network of certified dotcom pickup locations. This can be any brick and mortar location with excess refrigerator space, such as a restaurant or grocery store. It could also be one of the suppliers in B1 or B2. This facilitates ubiquity for the dotcom name at Internet speed. A customer would pick up their order at their chosen pickup site. Any member of this network of pickup locations would benefit from increased foot traffic from customers.

As shown in FIG. 1 as the progression of B1/B2 to B0 (b&m), or B0 (b&m) to B4, the trucks are the dotcom's trucks. Mail carrier refers to third party mail carriers.

In One Embodiment, the Method and System for Providing Food Service is Set Up as Follows:

A chosen chef and restaurant are showcased at the web site. The area's restaurants reflect the tastes of the surrounding area. The chef creates an entree. The ingredients and approximate preparation time are listed in the recipe along with the chefs name and restaurant at the web site.

The dotcom is accessible by PDA, PC, telephone, or other communication method. In this regard, customers have the ability to place orders in a wireless environment. It is a time saving service for the customer. The customer saves time by not having to shop, wash, or cut meal components and not having to look up recipes. It also can be a healthier way of eating.

The C0 to B0 Process, Activated by a Customer Executing an Order, is Executed, as Follows:

The user, that is, any food consumer, retrieves the menu of the day and places an order to the dotcom using any communication vehicle. If the order is executed through the web site, i.e., using a PDA or PC, the order can be encrypted and sent to the dotcom by e-mail.

The B0 to B13, B2 Process is Executed as Follows:

The encrypted e-mail or form is decrypted into the dotcom's database for processing. All the encrypted information sent by e-mail is decrypted and loaded into the database automatically. The order is processed and broken down into 2 components: (1) the protein component, and (2) the vegetable and spice components.

The dotcom confirms the order with the user by an e-mail communication and provides a reference, such as a web site page or URL, for the user to check the order's status.

The dotcom contacts the suppliers and places an order. The restaurant processes the non-protein components and the protein purveyor processes the protein component. The dotcom may choose to execute, i.e., process, each individual order immediately or to wait and compile a set number of orders and then execute the orders to the suppliers. The restaurants and protein purveyors have a capacity processing limit indicator in the dotcom's database, allowing the dotcom to know and decide which supplier to give the order to process. The capacity processing limit is the maximum number of orders one supplier can process at a given time for a given day. Each supplier will have its own capacity processing limit for each brick and mortar entity it processes. This limit will decrease as orders are given to be executed and will increase again as orders are completed. The suppliers are cycled through a list to ensure that each gets a share of the business and that maximum capacity is used.

The B1, B2 to B0 (b&m) Process is Executed, as Follows:

The processed component orders are picked up by the dotcom's trucks and brought to its brick and mortar locations for quality control, packaging, and distribution. Quality control checks are done on the orders processed by the suppliers. The orders that do not meet quality control are sent back. Orders that pass quality control are tagged and tracked, assembled, processed into the database, and packed with recipes into their respective kits. The packages are distributed according to their delivery instructions.

The B0 (b&m) to B3 to C0 Process, Delivery by Third Party Delivery Network, is Executed, as Follows:

Food/recipe packages to be delivered directly to the customer are delivered by the delivery network, comprising third party delivery services. The customer may incur an additional charge for this type of service. The dotcom is notified when the customer receives the package.

The B0 (b&m) to B4 to C0 Process is Executed as Follows:

Food/recipe packages to be picked up by the customer are delivered to the designated certified dotcom location by the dotcom's trucks. The dotcom is notified when the customer receives the package.

The B0 (b&m) to C0 via Mail Carrier Process is Executed, as Follows:

Food/recipe packages outside of the target city are shipped out by a mail carrier the cost of which the customer incurs. The dotcom receives verification when the customer receives the package.

Once received, the customer can prepare the meal from the ingredients according to the recipe immediately or store them in the refrigerator or freezer for later preparation. The customer should be pleasantly surprised by the quality of the meal and enjoy a great meal.

The method and system of the present invention can save consumers up to about 2-3 hours a day from extensive recipe lookups, ingredient shopping, and food preparation. It takes the pain of meal preparation away. Ingredients are washed, cut, measured, and ready to cook with instructions. The recipes are created by the area's finest chefs. The success rate of a scrumptiously prepared, possibly healthier, meal is high. The invention is “mom's care package all grown up.”

The invention is also an advertising vehicle. The restaurant and chef (or stores or markets) are showcased at the web site and receive free advertising. Customers become familiar with the restaurant and chef. The certified brick and mortar pickup locations receive free advertising. The delivery service vendors get more exposure. Customers recognize their names.

The invention is also a cooking instruction tool. The novice chef would find this service appealing for it can be used as a convenient introductory method of learning how to cook; with a high execution success rate, it can be an encouraging method. The invention allows cooking for one or many to be much easier than from scratch. One can easily entertain larger parties in this fashion.

The invention generates foot traffic at the certified brick and mortar pickup sites where users pick up their orders. As a result, users may buy items at those sites in addition to the food/recipe components.

The invention provides another revenue stream for the suppliers and distributors. Their downtime becomes uptime. They become productive during their downtimes and generate more business. The restaurant utilizes its downtime to process orders, keeping its kitchen staff busy. This may keep struggling restaurants in business, especially when dining out is reduced by a weakened economy.

As a marketing vehicle, through the invention, the consumer is exposed to the restaurant and chef. They develop a virtual rapport. The user becomes familiar with the chefs talents and may be more apt to dine at the chef's restaurant. For example, the user may be intrigued with the juxtaposition of certain ingredients in a recipe created by the chef and be more apt to try similar entrees at the chefs restaurant when dining out.

The consumer, who may be of a “couch potato” mentality, becomes more and more sophisticated with food and is more apt to try finer foods at fine restaurants. The restaurants are extending a virtual arm out to an untapped customer market base. The consumer also becomes more familiar and comfortable with the chef and restaurant and is more apt to dine at the restaurant. The restaurant can use the virtual rapport created by the present invention to draw in more customers.

Dining at home and dining out are not synonymous. This is evident to anyone who does the dishes. Dining out encompasses a whole different user experience: being waited on, not cooking, not cleaning, different atmosphere and environment, choice of food and drink, etc. The invention can encourage dining out.

The invention can also stimulate and/or generate innovation by ingredients/recipe suppliers, such as chefs. The chef can experiment with new creations at the dotcom to see the public's response. Participating with the dotcom allows an avenue for the chef to innovate and have more fun than what is normally allowed in the confines of a restaurant. The chef gets a virtual feel for the public's taste.

The protein purveyors increase their business. They have added another revenue stream by participating with the dotcom. It is an opportunity for them to do retail on a larger scale.

The method and system of the present invention remove the pain of meal preparation. They accommodate a busy mobile lifestyle; prompt non-tech savvy consumers to buy PDAs or other communication devices solely to use the method and system of the present invention; and improve the quality of life by allowing more time to do other things, while providing a great meal that one would normally not make in a typical day. Also, the method and system can provide better nutrition for consumers. The recipes can be changed frequently to avoid the doldrums. They enable fabulous meals at consumers' fingertips at a competitive price.

While illustrated and described above with reference to certain specific embodiments, the present invention is nevertheless not intended to be limited to the details shown. Rather, the present invention is directed to a method and system for providing ingredients and recipes for meal preparation to consumers and advertising to participating entities using a computer network, and various modifications may be made in the details within the scope and range of equivalents of the description and without departing from the spirit of the invention.

1. A method of providing components of a meal to a user, comprising:
receiving an order from the user, the order containing components of a meal;
allocating the components of the meal to suppliers wherein each component is assigned to a supplier;
notifying the assigned supplier of the component assigned to the assigned supplier; and
organizing distribution of the components of the meal to the user.

2. The method of claim 1 wherein the organizing distribution step comprises delivering the components of the meal to the user.

3. The method of claim 1 wherein the organizing distribution step comprises delivering the components of the meal to a location for pickup by the user.

4. The method of claim 1 further comprising, after the organizing distribution step, transmitting payment to suppliers.

5. The method of claim 1 further comprising, after the organizing distribution step, collecting payment from the user.

6. The method of claim 1 wherein the steps are controlled by a computer.

7. The method of claim 1 wherein the steps proceed via a computer network.

8. The method of claim 7 wherein the computer network is the Internet.

9. The method of claim 8 wherein the computer network is accessed through a land-based line or a wireless connection.

10. The method of claim 1 wherein the order further comprises criteria selected from the group consisting of quantity of components, delivery, pickup, delivery site, user address, pickup site, payment type, delivery time, pickup time, and price.

11. The method of claim 10 wherein the order is in a customized form for transmission through a computer network and the form is capable of being encrypted.

12. The method of claim 10 further comprising, after the receiving step, storing the order in an order database wherein the components and criteria are placed in fields of the order database.

13. The method of claim 12 wherein the allocating step comprises:
creating a database of component suppliers and criteria;
ranking the suppliers in the database; and
assigning suppliers for the components of the order based on the supplier ranking.

14. The method of claim 13 wherein the database of suppliers is based on and the ranking is performed from at least one member from the group consisting of availability, capacity, pricing, historical performance, and a system-defined variable.

15. The method of claim 13 wherein the database is updated in real time or according to a time interval.

16. The method of claim 1 comprising, after the notifying step:
receiving a negative response from a supplier assigned a component;
reassigning the component to a second supplier; and
repeating the receiving and reassigning steps until no negative response is received.

17. The method of claim 1 wherein the components of the meal are protein components selected from the group consisting of meat, poultry, and seafood and the supplier of the protein components is a protein purveyor.

18. The method of claim 1 wherein the components of the meal are vegetable and spice components and the supplier of the vegetable and spice components is a restaurant.

19. The method of claim 1 wherein the organizing distribution step comprises notifying the user of at least one of a delivery site, pickup site, delivery time, pickup time, and price.

20. The method of claim 10 wherein the components and criteria for each order of the user are stored as a user record in a user preference database.

21. The method of claim 20 further comprising, before the receiving an order step, transmitting information to a user based on the user record in the user preference database.

22. The method of claim 21 wherein the information is at least one member from the group consisting of a recipe, special meal, and special component.

23. The method of claim 1 further comprising, before the receiving an order step, transmitting information to a user.

24. The method of claim 23 wherein the information is at least one member from the group consisting of a recipe, special meal, and special component.

25. The method of claim 1 further comprising, after the organizing distribution step, assigning each component a tracking identification.

26. The method of claim 25 wherein the tracking identification is a scannable bar code, card, tag, or chip.

27. The method of claim 14 wherein there are multiple orders and further comprising:
ranking the priority of the orders based on the delivery time or pickup time; and
assigning suppliers based on the priority of the orders and the supplier rankings.

28. The method of claim 1 further comprising advertising a supplier to the user.

29. A system for providing components of a meal to a user, comprising a computer adapted to:
receive an order from the user, the order containing components of a meal;
allocate the components of the meal to suppliers, wherein each component is assigned to a supplier;
notify the assigned supplier of the component assigned to the assigned supplier; and
organize distribution of the components of the meal to the user.

30. The system of claim 29 further comprising a storage device in communication with the computer, the storage device adapted to store order information.

31. The system of claim 29 further comprising means for delivering the components of the meal to the user or a pickup location.

32. The system of claim 29 wherein the computer is adapted to transmit payment to suppliers.

33. The system of claim 29 wherein the computer is adapted to collect payment from the user.

34. The system of claim 29 further comprising a computer network.

35. The system of claim 34 wherein the computer network is the Internet.

36. The system of claim 29 wherein the order further comprises criteria selected from the group consisting of quantity of components, delivery, pickup, delivery site, user address, pickup site, payment type, delivery time, pickup time, and price.

37. The system of claim 36 wherein the order is in a customized form for transmission through a computer network and the form is capable of being encrypted.

38. The system of claim 36 further comprising:
a storage device in communication with the computer; and
a database residing on the storage device, the database comprising fields for storing the components and criteria of the order.

39. The system of claim 38 wherein the computer is adapted to create a database of component suppliers and criteria, rank the suppliers in the database, and assign suppliers for the components of the order based on the supplier ranking.

40. The system of claim 39 wherein the database of suppliers is based on and the ranking is performed from at least one member from the group consisting of availability, capacity, pricing, historical performance, and a system-defined variable.

41. The system of claim 39 wherein the database is adapted to be updated in real time or according to a time interval.

42. The system of claim 29 wherein the computer is adapted to receive a negative response from a supplier assigned a component, reassign the component to a second supplier, and repeat the receiving and reassigning until no negative response is received.

43. The system of claim 29 wherein the components of the meal are protein components selected from the group consisting of meat, poultry, and seafood and the supplier of the protein components is a protein purveyor.

44. The system of claim 29 wherein the components of the meal are vegetable and spice components and the supplier of the vegetable and spice components is a restaurant.

45. The system of claim 29 wherein the computer is adapted to notify the user of at least one of a delivery site, pickup site, delivery time, pickup time, and price.

46. The system of claim 36 further comprising a user preference database for storing the components and criteria for each order as a user record.

47. The system of claim 46 wherein the computer is adapted to transmit information to a user based on the user record in the user preference database.

48. The system of claim 47 wherein the information is at least one member from the group consisting of a recipe, special meal, and special component.

49. The system of claim 29 wherein the computer is adapted to transmit information to a user based on the user record in the user preference database.

50. The system of claim 49 wherein the information is at least one member from the group consisting of a recipe, special meal, and special component.

51. The system of claim 29 wherein the computer is adapted to assign each component a tracking identification.

52. The system of claim 51 wherein the tracking identification is a scannable bar code, card, tag, or chip.

53. The system of claim 39 wherein there are multiple orders and the computer is adapted to rank the priority of the orders based on the delivery time or pickup time and assign suppliers based on the priority of the orders and the supplier rankings.

54. The system of claim 29 wherein the computer is adapted to advertise a supplier to the user.

55. A computer-readable medium for providing components of a meal to a user having computer-executable instructions for performing the steps of:
receiving an order from the user, the order containing components of a meal;
allocating the components of the meal to suppliers wherein each component is assigned to a supplier;
notifying the assigned supplier of the component assigned to the assigned supplier; and
organizing distribution of the components of the meal to the user.

56. The computer-readable medium of claim 55 wherein the organizing distribution step comprises delivering the components of the meal to the user.

57. The computer-readable medium of claim 55 wherein the organizing distribution step comprises delivering the components of the meal to a location for pickup by the user.

58. The computer-readable medium of claim 55 further comprising, after the organizing distribution step, transmitting payment to suppliers.

59. The computer-readable medium of claim 55 further comprising, after the organizing distribution step, collecting payment from the user.

60. The computer-readable medium of claim 55 wherein the steps are controlled by a computer.

61. The computer-readable medium of claim 55 wherein the steps proceed via a computer network.

62. The computer-readable medium of claim 61 wherein the computer network is the Internet.

63. The computer-readable medium of claim 62 wherein the computer network is accessed through a land-based line or a wireless connection.

64. The computer-readable medium of claim 55 wherein the order further comprises criteria selected from the group consisting of quantity of components, delivery, pickup, delivery site, user address, pickup site, payment type, delivery time, pickup time, and price.

65. The computer-readable medium of claim 64 wherein the order is in a customized form for transmission through a computer network and the form is capable of being encrypted.

66. The computer-readable medium of claim 64 further comprising, after the receiving step, storing the order in an order database wherein the components and criteria are placed in fields of the order database.

67. The computer-readable medium of claim 66 wherein the allocating step comprises:
creating a database of component suppliers and criteria;
ranking the suppliers in the database; and
assigning suppliers for the components of the order based on the supplier ranking.

68. The computer-readable medium of claim 67 wherein the database of suppliers is based on and the ranking is performed from at least one member from the group consisting of availability, capacity, pricing, historical performance, and a system-defined variable.

69. The computer-readable medium of claim 67 wherein the database is updated in real time or according to a time interval.

70. The computer-readable medium of claim 55 comprising, after the notifying step:
receiving a negative response from a supplier assigned a component;
reassigning the component to a second supplier; and
repeating the receiving and reassigning steps until no negative response is received.

71. The computer-readable medium of claim 55 wherein the components of the meal are protein components selected from the group consisting of meat, poultry, and seafood and the supplier of the protein components is a protein purveyor.

72. The computer-readable medium of claim 55 wherein the components of the meal are vegetable and spice components and the supplier of the vegetable and spice components is a restaurant.

73. The computer-readable medium of claim 55 wherein the organizing distribution step comprises notifying the user of at least one of a delivery site, pickup site, delivery time, pickup time, and price.

74. The computer-readable medium of claim 64 wherein the components and criteria for each order of the user are stored as a user record in a user preference database.

75. The computer-readable medium of claim 74 further comprising, before the receiving an order step, transmitting information to a user based on the user record in the user preference database.

76. The computer-readable medium of claim 75 wherein the information is at least one member from the group consisting of a recipe, special meal, and special component.

77. The computer-readable medium of claim 55 further comprising, before the receiving an order step, transmitting information to a user.

78. The computer-readable medium of claim 77 wherein the information is at least one member from the group consisting of a recipe, special meal, and special component.

79. The computer-readable medium of claim 55 further comprising, after the organizing distribution step, assigning each component a tracking identification.

80. The computer-readable medium of claim 79 wherein the tracking identification is a scannable bar code, card, tag, or chip.

81. The computer-readable medium of claim 68 wherein there are multiple orders and further comprising:
ranking the priority of the orders based on the delivery time or pickup time; and
assigning suppliers based on the priority of the orders and the supplier rankings.

82. The computer-readable medium of claim 55 further comprising advertising a supplier to the user.
